(19) United States
(12) Patent Application Publication
(10) Pub. No.: US 2007/0107349 A1
(43) Pub. Date: May 17, 2007

(54) Prefabricated modular architectural wall panel

(76) Inventor: Jeffery W. Erker, Chesterfield, MO (US)

Correspondence Address: Paul M. Denk, Suite 170, 763 S. New Ballas Rd., St.Louis, MO, 63141, US

(21) Appl. No.: 11/542,357

(22) Filed: Oct. 3, 2006

Related U.S. Application Data
(60) Provisional application No. 60/723,534, filed on Oct. 4, 2005.

(51) Int. Cl. E06B 3/70

(52) U.S. Cl. 52/455

(57) ABSTRACT

Wainscot wall panels made at a manufacturing plant through either the cut and assembly of the various components that make up the panel, through routing of a lumber, plywood, or other material, then assembled into a prefabricated wainscot, for later shipment and installation at the home or jobsite during construction or renovation. The panels have three piece construction with a center panel, rails above and below the center panel, and half and full stiles flanking the center panel and perpendicular to the rails. Alternatively, the raised panel, rails, and stiles can be routed or pressed from a single piece of wooden material.

### CROSS REFERENCE TO RELATED APPLICATION

This non-provisional application claims priority to the provisional application with a Ser. No. of 60/723,534 with a filing date of Oct. 4, 2006 which is commonly owned by the same inventor.

### BACKGROUND OF THE INVENTION

Various types of decorative panels, wainscot, chair rails, and the like, have long been used upon the surface of walls, normally as a lower segment, to decorate a wall, but also, to furnish a protective covering, for the wall, so that whatever furniture, individuals, or other items encounter the wall, damage will be minimized. Nevertheless, these types of decoration added to a wall have also been used for just that purpose: to add to the pleasing aesthetic appearance of a wall and thus enhance the attractiveness of the room.

As is well known, wainscots have been applied to the walls in rooms, particularly of the more fancy homes, that were built at the turn of the twentieth century. Early on, the cheaper and faster to construct housing in the boom years of the late 1940s and 1950s and the minimalist homes designed in the 1960s and 1970s are receiving much needed decor upgrades, often from decorators, handymen, kitchen and bath re-modelers, and quite often the homeowners themselves. Additional, new homes, both high end and modest, are receiving the architectural attention that they lacked for many years. The increasing popularity of traditional and classical style of home décor has usage of architectural trim exploding. The looks of goods sold by stores such as Pottery Barn, Crate & Barrel, and Restoration Hardware are desired by homeowners and architects alike. Many of these architectural elements are from the English Georgian period circa the 1700s, the American Federal period, the Arts and Craft movement, and the Victorian style. These architectural inspirations coupled with the increased availability of numerous styles of trim, chair rails, crown molding, and baseboards, has brought about the return of classical trim in homes, not only the high end residences but the average American home.

The security of real estate investments in residential housing has lead to a robust grown in the home improvement and home building market. When a home's worth is often linked to the owner's ability to use its equity, home improvement is on the top of homeowner's minds. Homes builders are equally motivated to use value added options to achieve higher sales volumes and the sought after higher sales margins. This growth appears in the number of successful large and small home improvement companies, home improvement centers, and construction companies.

The push for home improvement and the offerings for easy solutions to homeowners have left a gap in the areas that require expensive equipment and moderate skill in woodworking. Finished millwork proves difficult for homeowners to find at local home improvement centers nor can builders provide at an affordable price.

Currently, achieving a classic look varies from wall covering to special paint finishes, wall frames, chair rails, and to wainscoting. Most home owners live with the walls at the time of purchasing the house, while struggling to find a way to attain that classic look for the rooms that will host their friends and family, and appears luxurious. Nothing completes or finishes a room like wainscot, which offers a special look but at a steep price.

Presently, no wainscoting is available for the average homeowner or builder seeking a low price optional extra for a house. Existing products generally remain within chair rails or wall frames. The cost of labor for installing a wall frame makes it cost prohibitive. Little on the market today compares to the classic look of raised panel wainscot.

Traditional wainscot consists of long wooden pieces, or rails, which run horizontally along a wall's length, above and below the wainscot panels, short vertical pieces, or stiles, that separate the panels, and the panels themselves. The parts are generally fit with tongue and groove joinery upon perimeter edges. Each piece is likely custom cut for installation.

### SUMMARY OF THE INVENTION

This invention relates generally to the addition of pre-fabricated modular, or complete, architectural wall panels, in the nature of a wainscot, that may be conveniently, easily, and properly, fitted to a wall during construction or renovation.

The wainscot wall panel of this invention is completely fabricated, or made of, finished wood components, with raised panels and stiles forming the wainscot panel. The design reflects traditional custom built raised panel type wainscoting: raised panels framed by rails and stiles. The panels are cut, or milled, from MDF (Medium Denisty Fiber Board), natural wood products, or other materials, such as composite materials. The unique proportions of the panel with respect to the raised panel detailing allows for greater flexibility and versatility along any length wall or with any width window, to any height from the floor, while maintaining a custom, crisp, clean look to the finished room.

The wall panel of this invention is detailed with a number of raised panels, evenly spaced, and separated by stiles. At one end, an assembly of panel ends with one-half of a stile. This allows for abutting together adjacent panels, of identical panel design, resulting in a continuous pattern of raised panels alternating with stiles, all evenly spaced. The opposite panel ends with a flat plane, or stile, with approximately the same width as the raised panels. This allows for trimming of the panel's length to accommodate the wall's dimensions without interfering with the raised panel and stile pattern.

The wall panel dimensions are consistent with typical residential room sizes to minimize the number of panels required, the installation time, and ease of their transfer during construction. The standard panel proportions and design allows for the wide stile end portion of panel to be trimmed, as with one vertical cut, to accurately accommodate differing wall dimensions. Because of its symmetry, the same top and bottom rail heights, the panel can be rotated one-hundred and eighty (180) degrees to accommodate a finished left or right hand corner while allowing continuity of panel detail, rail, and stile pattern spacing.

Addressing wall dimensions that are greater or less than two wainscot wall panels butted together, may require an additional vertical cut down the center of a stile pattern to increase or decrease the overall modular length of the wall panels.

Due to the spacing on the panel, the panel's proportions, and its standard dimensions, working the wainscot wall panel below windows that are less than the standard height of the panel is greatly simplified and requires no custom made panels or milling as later shown in FIG. 7-9. The wainscot wall panel can be turned vertical, and trimmed appropriately by the installer, to address the particular window's height and width. Additionally, a continuous raised panel line above the baseboard can be maintained if desired. The panel dimensions and pattern placement allows for trimming to suit narrower windows, while maintaining a consistent stile width or pattern throughout the wall.

The unique proportions of the panels include a raised center panel surrounded by perimeter flat flanges. These proportions and features, with respect to the raised panel detailing, allow for greater flexibility and versatility with any length wall or any width window at any height from the floor, while maintaining a custom, crisp, clean look to the finished room.

The raised panel, stile and rail patterns for assembling the wainscot of this invention may be categorized as follows:

1. The pattern is achieved by traditional methods of assembling stiles, rails, and raised panels to the approximate dimensions noted above with symmetrical top and bottom rails, one-half stile on one end, and approximately one full panel width stile on the opposite end. The raised panel portions may have other patterns cut into them, to furnish additional aesthetic detailing for the formed panel.

2. The pattern is milled, or routed, into the center piece to separate rails to the appropriate proportions as noted above. The three piece approach allows for the custom appearance to be maintained, a butt joint between the rails and stiles, as well as crisp ninety (90) degree corners in the detail pattern.

Additionally, when natural wood products are used and grain direction is important, this approach allows for the stiles and patterns to maintain vertical orientation of the grain, and the rails to maintain a horizontal grain, further preserving the custom look in a standard panel approach. The raised panel portions may have other patterns cut into them, to furnish additional aesthetic detailing for the formed panel.

3. The pattern is milled, or routed, into one solid board with the appropriate proportions as noted above. Contours of the rails, stiles, and raised panels are cut into the single work piece and nothing is cut separately. The raised panel portions may have other patterns cut into them, to furnish additional aesthetic detailing for the formed panel

4. The pattern is cast from a mold and inserted into an opening cut in the board with the appropriate proportions noted above. This results in one board with the pattern of rails, stiles and raised panels.

5. The entire panel and detailing, with the appropriate proportions noted above, can be formed by an injection molding process.

Regardless of panel construction methods, the panels can be permanently attached to existing wall surfaces, such as drywall, brick, plaster, and the like, with common fasteners such as nails, screws or construction adhesive. In new construction and in certain applications, panels can be fixed directly to the wall studs.

Additional trim and base boards can be added by the installer to dress up the wall panels and add the finished look to the final installation. Screws or nails used to secure the panels can be hidden by the baseboard or chair rail trim at the bottom and top of the panels eliminating the need to fill or patch the panels.

Openings for electrical outlets, phone jacks, and the like, must be measured and cut by the installer. The raised panel, rail, and stile pattern is designed for standard height outlets, to be cut into the raised panel portion of the pattern, without interfering with the pattern contours.

It is, therefore, the principal object of this invention to provide wainscot wall paneling that may be pre-fabricated into custom segments, which may be easily cut and fitted into the construction or renovation of a room for a home or building.

Another object of this invention to provide for completely pre-fabricated and primed or wood finished raised panel stile wainscoting wall panels, that may be readily applied to the wall during new construction, or during room renovation.

Another object of this invention is to provide custom made pre-assembled wainscot panels that may be readily fitted and applied into a room or building, to alleviate the need to cut custom pieces and assemble such overall panels within a room during its building or renovation.

Another object of this invention is to provide means to facilitate and ease the method in which wall paneling may be applied in a building.

A further object of this invention is to provide a means for the manufacturer and assembly of wainscot wall panels at a manufacturing plant, for shipment to a building site, installer, or a retail outlet.

These and other objects may become more apparent to those skilled in the art upon review of the summary of the invention as provided herein, and upon undertaking a study of the description of its preferred embodiment, in view of the drawings.

### BRIEF DESCRIPTION OF THE DRAWINGS

In referring to the drawings,

FIG. 1 shows an assembly of a pre-manufactured standard wainscot wall panel;

FIG. 2 shows the various components that are pre-fitted and assembled into a standard wainscot wall panel, FIG. 2A shows an exploded view of the components, FIG. 2B describes the fit of the raised panel into a rail, FIG. 2C then shows the fit of a rail with a stile or end panel;

FIG. 3 shows the various sections that are joined together generally by tongue and groove joinery to form the pre-manufactured wall panels, FIG. 3A shows an exploded view of the components and the single piece panel, FIG. 3B illustrates the fits of the raised panel into a stile, FIG. 3C describes the fit of a rail to a raised panel;

FIG. 4 shows the complete one piece construction of the pre-manufactured standard wainscot wall panel, FIG. 4A describes the routing that forms the apparent joint of a raised panel with a stile;

FIG. 5A shows the various wall panel arrangements for various lengths of walls and FIG. 5B describes the various wall panel arrangements, including shortened panels, around a window opening;

FIG. 6A shows the individual standard panels cut to appropriate lengths and assembled into a room along a wall following a panel layout shown in FIG. 6B;

FIG. 7 shows a perspective view of the panels as assembled into a room, along a wall with a window, noting the method of fitting below a lower window structure;

FIG. 8 shows the various routing and shaping details for the panels, rails, stiles, and even the raised panels for the wainscot of this invention along with further routing and shaping details for one piece pre-fabricated panels;

FIG. 9 describes the continuous routing of a single panel; and,

FIG. 10 provides a view of the raised panel centrally located within the prefabricated wainscot, and alternate detailing for aesthetics of the formed panel.

### DESCRIPTION OF THE PREFERRED EMBODIMENT

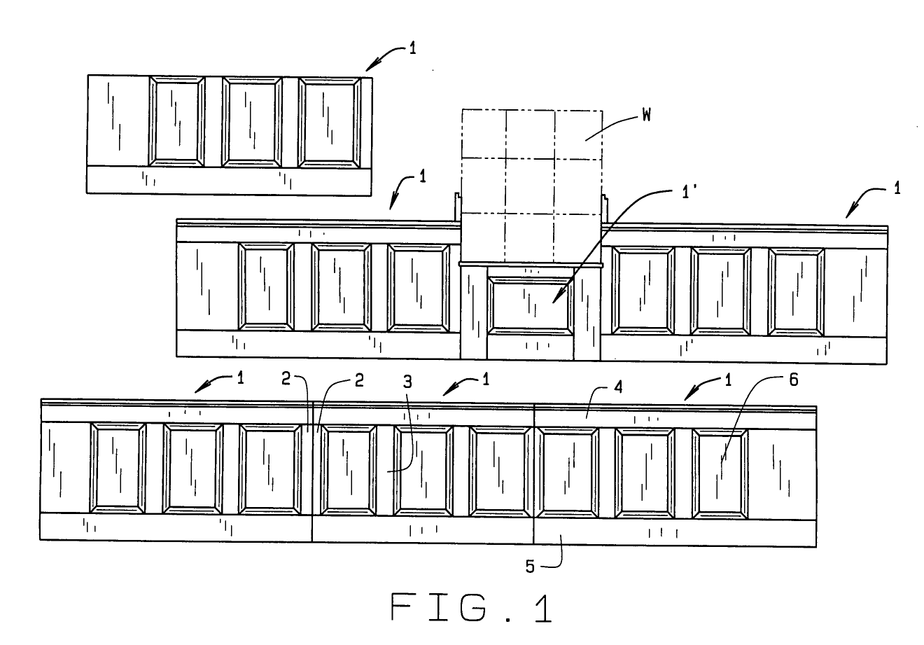

In referring to the drawings, and in particular FIG. 1, this particular figure shows in various views the application and usage of the pre-fabricated wainscot wall panels 1 of this invention. Preferably the panels are made of wood. They may be simply applied end to end, as along their mating of the one-half stiles, as at 2, together, in order to form a complete stile, such as shown normally at 3, with the upper and lower rails 4 and 5, respectively, forming the peripheral structure for the raised panels 6 for each panel section 1. As can also be seen in FIG. 1, these panels 1′ may be abutted beneath a window, as at W, to add to the attractiveness of the room, as the panels are being installed during custom construction, or during remodeling of a room.

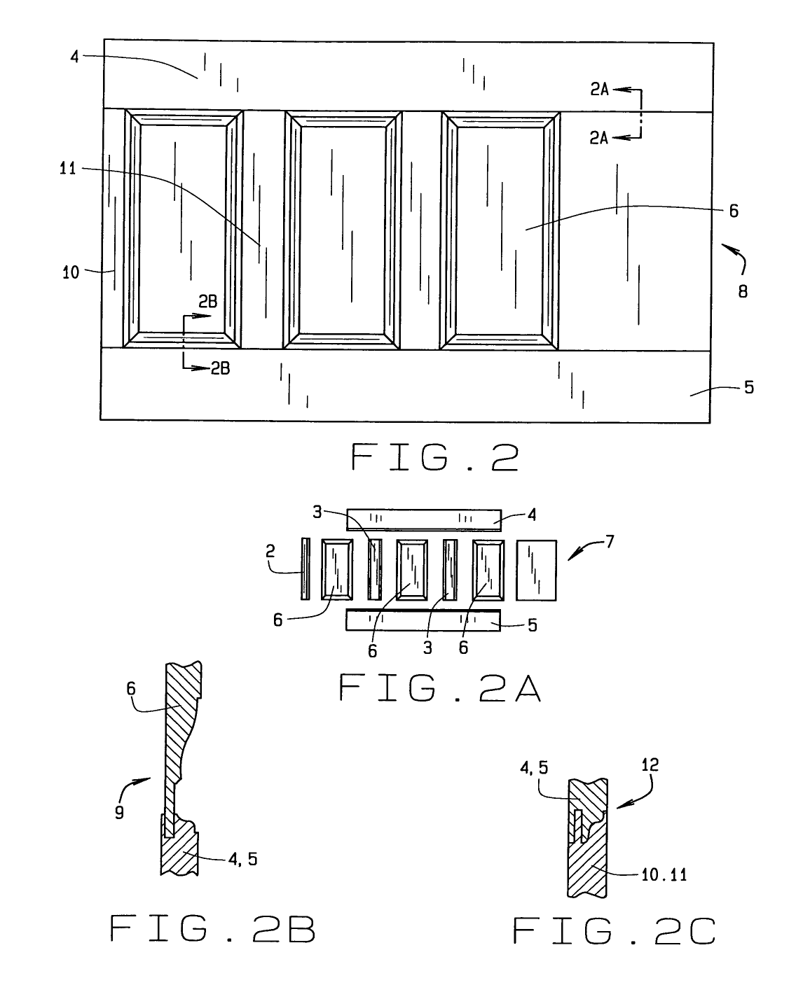

These types of panels can be fabricated either custom on the jobsite or standardized at the manufacturing plant, generally in the manner as shown in FIG. 2, wherein the miscellaneous components that make up a panel can be seen at FIG. 2A, in an exploded view, but that when the various components are assembled, they are formed into the complete panel, as noted at 8, and can be shipped from the factory to the jobsite, where they may be applied to a wall. The various components that make up the panels can be seen at FIG. 2B, where a stile and rail construction, using mortis and tenon joinery can be used for assembling the components together, in the construction of a complete panel. And, as can be noted, half stiles, as at 10, can be formed at either end of the panel, so that when adjacent panels are applied in line, along an entire wall, a pair of the half stiles form a full stile, of the type and width as shown at 11, to add continuity to the paneling when applied, one next to the other, during construction. The rail and stile connection, as at FIG. 2C, forms the upper connection between a rail, and a stile, during assembly.

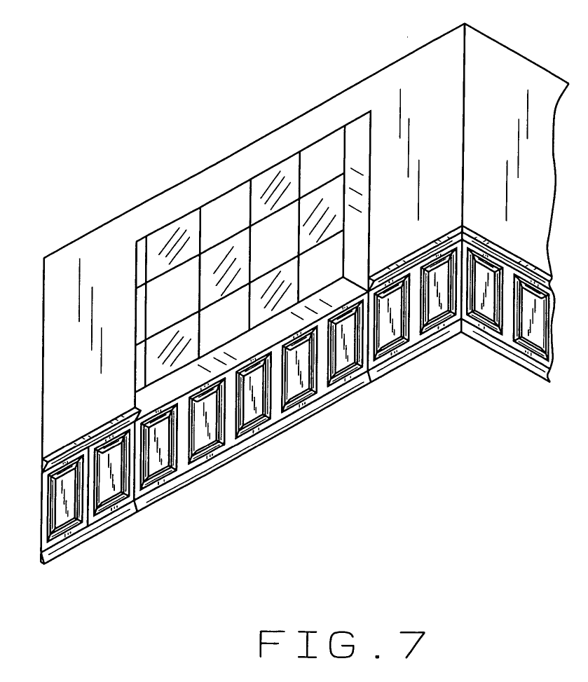

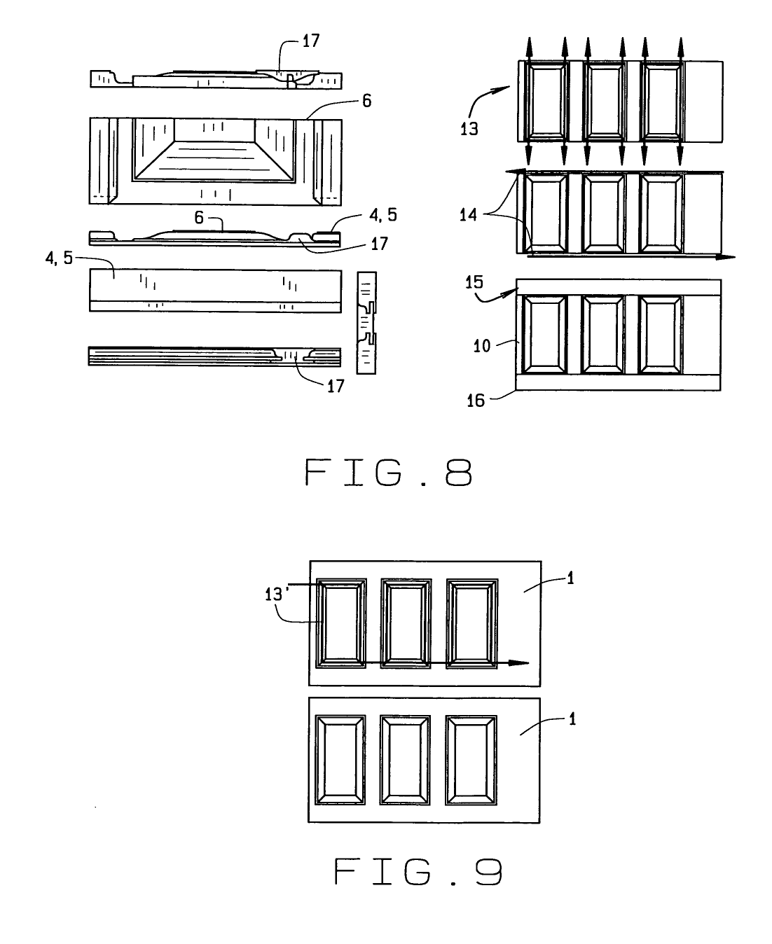

A second method for this invention, for construction of the wainscot wall panels can later be seen in FIGS. 8, 9. In this instance, rather than assembling components into the formed panel, a sheet of wood, that will be of a height for the intended panel, and having a corresponding width to the width of the panel desired, can be routed by a bit 17, in the manner as shown in the right of FIG. 8, wherein longitudinal and lateral routing, through the use of a computerized router, can take the paths for routing as shown at 13, while additional routing can be done at the upper and lower rail sections, as 14. Then, the upper rail and bottom rail can be applied, as shown at 15 and 16 respectively, to complete the finally assembled panel. Additional pathways of the bit 17 are shown in the left of FIG. 8 that form the raised panel 6 and the rails 4, 5.

Nevertheless shown in FIG. 9, most of the components used to form the panel, will be routed by a bit 17, and cut from a singular board, rather than requiring the custom fitting of a variety of pre-cut sections together, in the manner as previously explained for FIG. 2. FIG. 9 also shows another tool path detail, for the routing and shaping details, for construction of the wainscot wall panels, in a manner as previously described in 8. This tool path is continuous as the tool need not be lifted from the work piece, thus reducing manufacturing time and cost. Hence, the wainscot wall panels can be constructed and formed in two ways, one either by custom assembly, at the plant, or by significant routing, through a continuous pre-programmed routing technique in order to cut the paneling into the appearance of a wainscot, for final application of its rails, to complete a panel ready for shipment.

These types of panels can be constructed to almost any size, have a standardized height of three to four feet, and a standardized width from four to eight feet, depending upon the dimensions required for the building in which these panels are to be installed. A computer can regulate these dimensions at a manufacturing plant, when a variety of such panels are to be manufactured, for a particular job. Essentially, the invention eliminates the need for custom cutting and assembly of the wainscot, at the jobsite. Custom cutting can be a very expensive operation with costly wood or other products and skilled labor to complete such tasks. In this invention, the wainscot panels are constructed at the manufacturing plant, shipped to a jobsite and installed by nails, manufacture's glue, adhesives and the like, to locate the panels in place rapidly to finish a job.

Alternatively, the wainscot panels, including their constituent parts of rails, stiles, and raised panels, can be formed by pressure with lumber or other material placed within a mold. The mold has the shapes of the desired finished panel and then the mold is applied to a single sheet of material at high pressure. The high pressure alters the planar sheet into the shape of the mold. This method of assembly is particularly suited to glue laminated material where a semi-plastic mixture of wood chips and resin flows into a mold and then attains a finished shape under the pressure of the mold. Alternatively, the panels can be made from wood chips, chip board, plastics and composites.

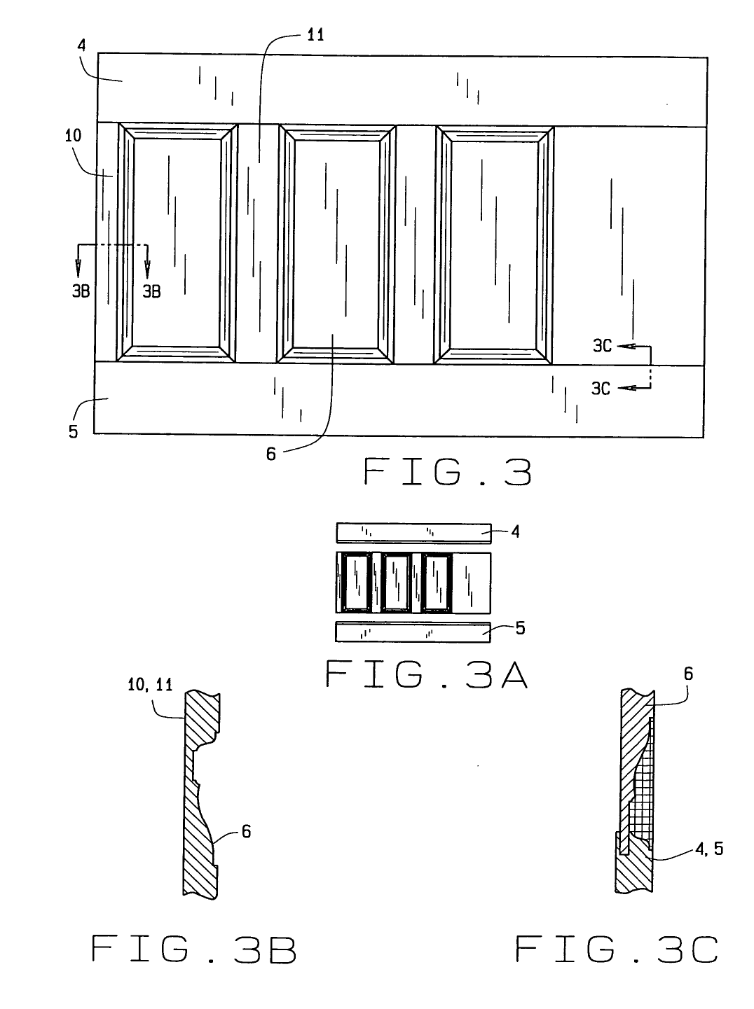

FIG. 3 shows further assembly of the pre-manufacture's standard wainscot wall panel, in the manner as previously explained in FIG. 2, showing how the various components may be custom fitted, into a main panel section, at the manufacturing plant, or which may even be assembled at the job site. An exploded view in FIG. 3A shows the pieces that assemble into a panel upon the job site bounded by rails. FIG. 3B illustrates the shaping of the connection that forms a wall panel adjacent to a stile. The shaping has sharp features to denote the edge of a stile and more gradual features to denote the border of the wall panel 6. FIG. 3C describes the joining of a wall panel to a rail with an end panel, here towards the right, beyond the foreground of the joint. The wall panel provides a tenon that inserts into a mortis like groove upon the longitudinal edge of a rail.

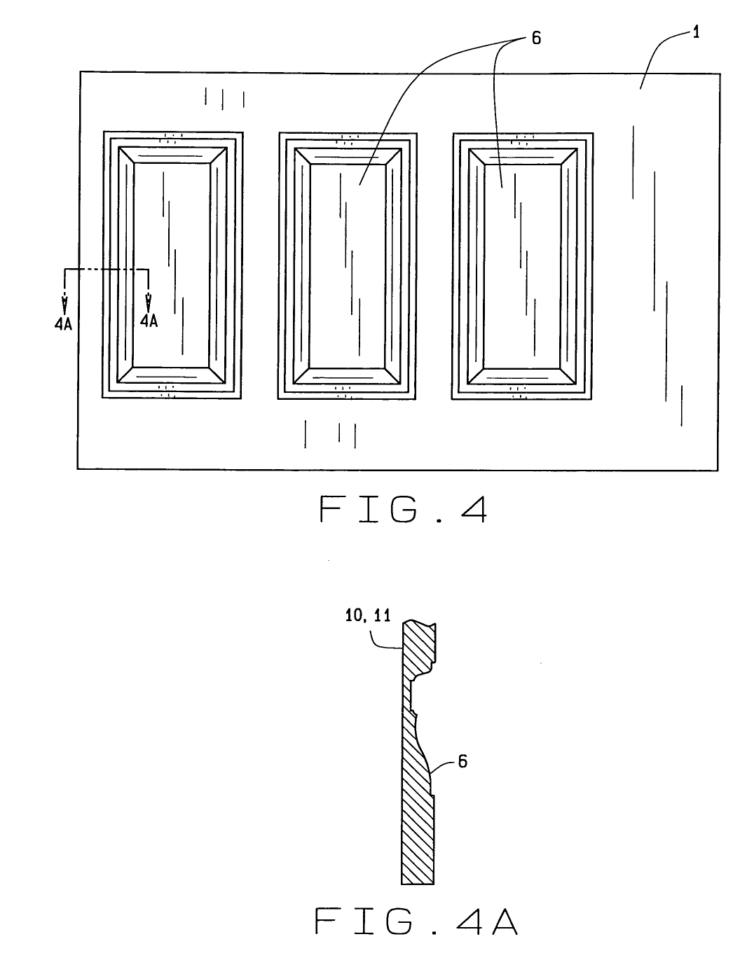

FIG. 4 shows further construction methods for a one piece construction of a wainscot wall panel, in preparation for assembly and usage. The single piece panel has a design manufactured by routing of the design by a computer controlled router or by a press having a mold bearing the design. FIG. 4A further illustrates the routing of a wall panel at the border where the raised panel abuts a stile 10, 11. The raised panel has gradual features denoting its border while the stile has sharper features.

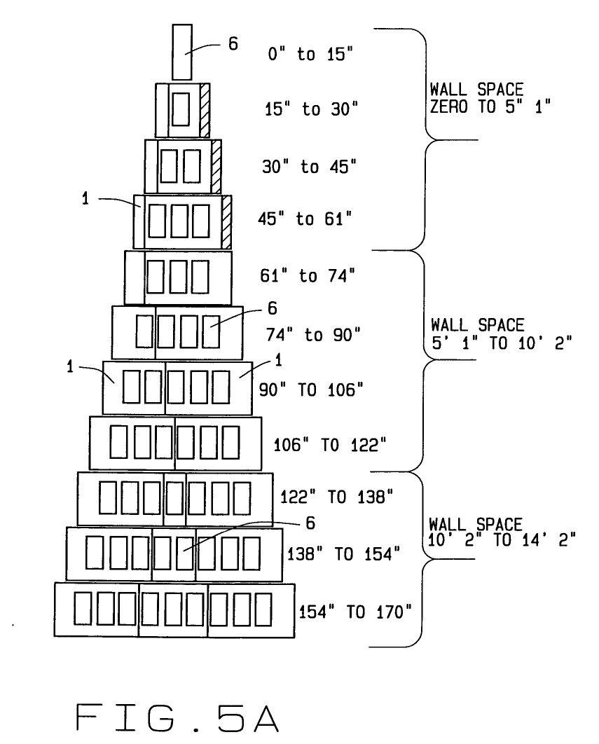

FIG. 5A shows the various lengths of wall paneling, that may be made to specified wall sizing details, at the manufacturing plant, for later assembly within rooms. The assembly may apply the wall panel directly against the wall, throughout its entire length, or as located adjacent a fireplace, or windows following the template in FIG. 5B. Other standard type cuts can be made at the job site, by the installer, where the paneling may be required to fit around or under windows, and the like.

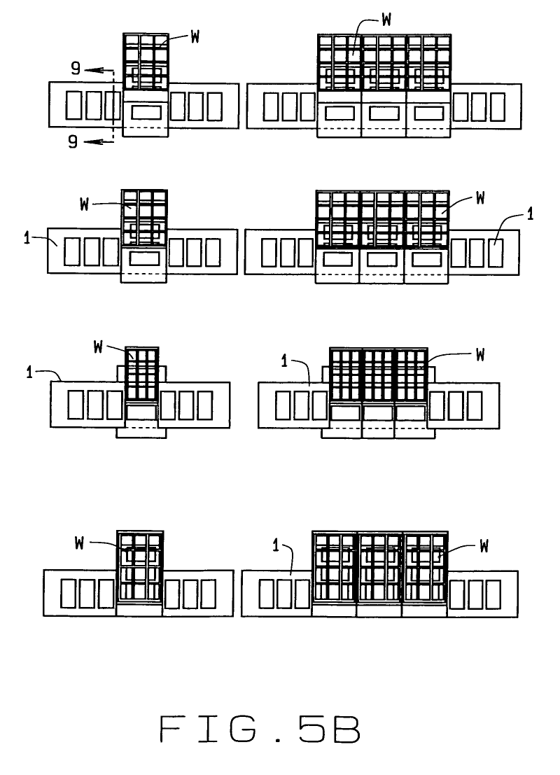

FIG. 6A shows a finished application of the wainscot wall panels primarily to a room wall, along the length of a wall, and secondarily below a window. As shown in FIG. 6B, four panels complete the entire structured paneling, for half of the room.

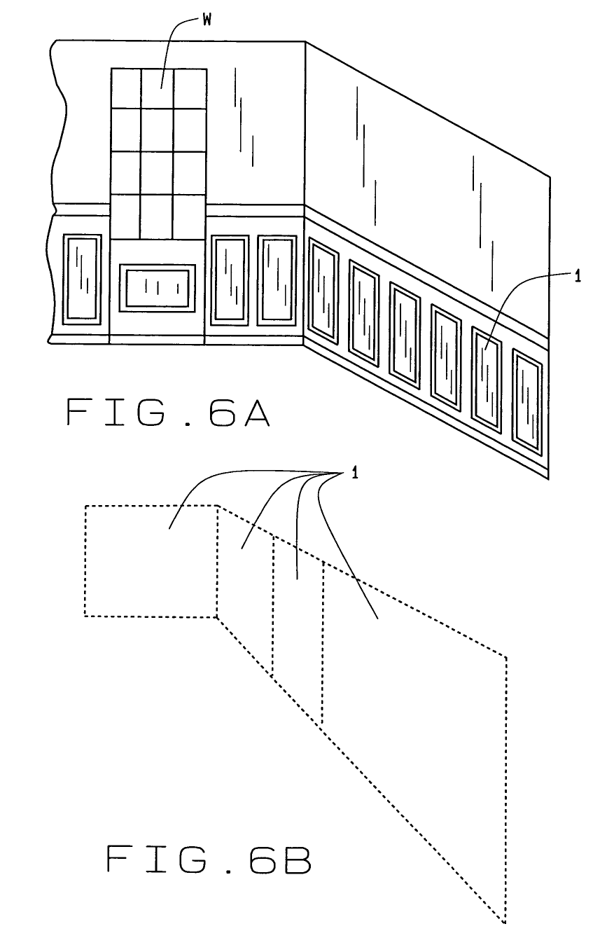

FIG. 7 shows a perspective view of the application of the wainscot wall panels around a window and along a wall. Here the panels below the window sill are of lesser height than the remaining panels throughout the room.

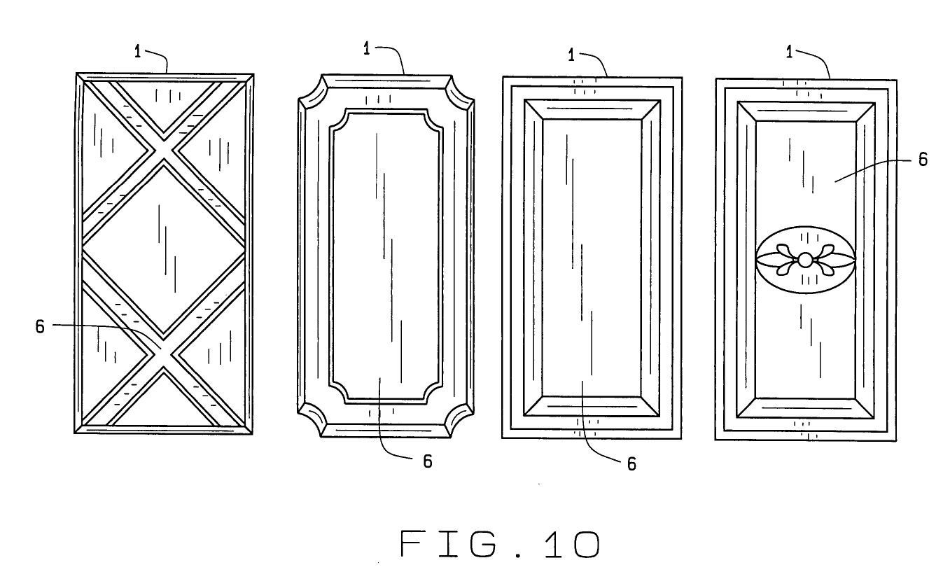

FIG. 10 provides a view of the raised panel, furnished and located centrally within the prefabricated wainscot. This figure also discloses how other detailing may add to the aesthetics of the formed panel, whether through custom assembly or routing. As before, this is for the paneling constructed through the continuous routing method, at the manufacturing plant, to provide finished paneling with detailed dimensions, ready for shipment and application to a room, simply through minor cutting, and then through application by means of nails, or construction adhesive, to the wall of the room being constructed, or remodeled.

The foregoing provides a general description of the details of assembly, of the wainscot wall panels, at the manufacturing plant, rather than requiring the custom cutting and assembly upon a room wall, by a carpenter, as done in prior art wainscot paneling of a building or room. The preceding description shows the application of wainscot paneling can be done rapidly, less expensively, but yet have just as attractive appearance and more uniform dimensions, through the usage of this invention.

Variations or modifications of the subject matter of this invention may occur to those skilled in the art upon reviewing the development as described herein. Such variations, if within the spirit of this development, are intended to be encompassed within the scope of the invention as described herein. The description of the preferred embodiment and of the drawings showing the same are provided herein for illustrative purposes only.

1. A system of wainscot paneling comprising:
a plurality of panels having standardized dimensions, said panels connecting to one another; and,
each of said panels having two parallel horizontal spaced apart members, at least two vertical members spanning between said horizontal members, and at least one raised panel securing within said horizontal members and said vertical members, said raised panel, said horizontal members, and said vertical members having joined connections.

2. The wainscot paneling system of claim 1 wherein said horizontal members are rails, and said vertical members are stiles.

3. The wainscot paneling system of claim 2 further comprising:
said stiles having a standardized full width; and,
at least one half stile having one half of a standardized full width.

4. The wainscot paneling system of claim 3 further comprising:
said rails having an upper rail and a lower rail; and,
said upper rail, said lower rail, said raised panel, said stiles, and said half stile mutually connecting with mortise and tenon joinery.

5. The wainscot paneling system of claim 4 further comprising:
said upper rail, said lower rail, said raised panel, said stiles, and said half stiles being fabricated at a manufacturing plant then preassembled and fitted together into one of said panels for shipment to a remote site for installation.

6. The wainscot paneling system of claim 1 furthering comprising:
each of said panels having a generally planar shape upon which is formed said horizontal members, said vertical members, and said raised panels at a manufacturing plant for later shipment to a remote site for installation.

7. The wainscot paneling system of claim 6 further comprising:
said horizontal members having a horizontal upper rail and a parallel and spaced apart lower rail;
said vertical members having at least one stile of a full width and at least one stile of a half width; and,
at least one raised panel bounded by said upper rail, said lower rail, and said stile.

8. The wainscot paneling system of claim 7 further comprising:
said upper rail, said lower rail, said stiles, said half stiles, and said raised panels being made by routing.

9. The wainscot paneling system of claim 8 wherein said routing is continuous where the router remains upon said panel when cutting said upper rail, said lower rail, said stiles, said half stiles, and said raised panels.

10. The wainscot paneling system of claim 8 wherein said routing is discontinuous where the router is lifted and repositioned upon said panel when cutting said upper rail, said lower rail, said stiles, said half stiles, and said raised panels.

11. The wainscot paneling system of claim 8 wherein said panels are formed from one of wood, wood chips with resin, plastic, or composite.

12. The wainscot paneling system of claim 7 further comprising:
said upper rail, said lower rail, said stiles, said half stiles, and said raised panels are made by a mold pressed upon said single sheet.

13. The wainscot paneling system of claim 12 wherein said panels are formed from one of wood, wood chips with resin, chipboard, plastics, or composites.

14. The wainscot paneling system of claim 1 further comprising:
said horizontal members connecting to said vertical members with joinery.

15. The wainscot paneling system of claim 14 further comprising:
said vertical members being stiles.

16. The wainscot paneling system of claim 15 further comprising:
said stiles alternating with said panels along an installation of said system.

17. The wainscot paneling system of claim 16 further comprising:
said stiles and said panels having the capability of fitting along a staircase.

18. The wainscot paneling system of claim 14 wherein said horizontal members connect to said vertical members by one of tongue and groove, mortise and tenon, or dowel and socket.

19. The wainscot paneling system of claim 1 further comprising:
said panels having the capability of custom fitting below windows, adjacent to fireplaces, adjacent to doors, along a staircase, and for accommodating utility openings.

20. The wainscot paneling system of claim 1 further comprising:
trim attaching upon the top of said horizontal member above said raised panel.

21. A system of wainscot paneling comprising:
a plurality of panels having standardized dimensions, each of said panels having a generally planar shape formed from a single piece, at least one rail like section adjacent to and coplanar with at least one raised panel, said rail like section having at least two routed perimeter edges; and,
a plurality of stiles, each of said stiles spacing apart one of said panels from another of said panels, each of said stiles having lesser width than one of said panels, similar length to one of said panels, and at least partially routed longitudinal edges that cooperate in a joined connection with the edges of said rail like section of an adjacent one of said panels,
thus assembling said panels and said stiles as a system upon a wall proximate a floor.

22. The wainscot paneling system of claim 21 further comprising each of said panels having four edges in two opposing pairs.

23. The wainscot paneling system of claim 22 wherein each of said panels is one of rectangular, square, or quadrilateral and each of said stiles is rectangular or quadrilateral.

24. The wainscot paneling system of claim 21 further comprising:
said rail like section having
two lateral edges mutually parallel and spaced apart, generally parallel to the length of said panel, said lateral edges routed to accept a routed longitudinal edge of one of said stiles, and
two longitudinal edges, mutually parallel and spaced apart, generally parallel to the width of said panel, said longitudinal edge proximate said raised panel being routed similar to the longitudinal edges of one of said stiles.

25. The wainscot paneling system of claim 24 further comprising:
each of said stiles having longitudinal edges routed full length, the longitudinal edges of said stiles cooperating with the longitudinal edge of said rail like section proximate said raised panel to frame said raised panel.

26. The wainscot paneling system of claim 24 further comprising:
each of said panels being symmetric and having two spaced apart rail like sections outwardly of said raised panel.

27. The wainscot paneling system of claim 24 wherein each of said stiles is generally perpendicular to an adjacent rail like section of a panel.

28. A device for decorating an interior wall of a building, comprising:
a panel having standardized dimensions, two parallel horizontal spaced apart rails, at least one vertical stile spanning between said rails, and at least one raised panel securing within said rails and said at least one stile, said rails and said stiles having joined connections.

29. The decorating device of claim 28 further comprising:
each of said rails having two spaced apart parallel lateral edges extending parallel to the length of said panel;
each of said stiles having two spaced apart parallel longitudinal edges; and,
one of said lateral edges of said rail joining to one of said longitudinal edges of said stile with joinery.

30. The decorative device of claim 28 further comprising:
said panel having two spaced apart longitudinal edges;
each of said stiles having two spaced apart parallel longitudinal edges, said longitudinal edges being at least partially machined; and,
one of said longitudinal edges of said stile joining to one of said longitudinal edges of said panel with joinery.

31. The decorative device of claim 28 further comprising:
said device having a top generally opposite the floor when installed; and,
trim attaching upon said top.
